(19) United States
(12) Patent Application Publication
(10) Pub. No.: US 2012/0067737 A1
(43) Pub. Date: Mar. 22, 2012

(54) METHOD AND APPARATUS FOR FORMING PARTICLES AND FOR RECOVERING ELECTROCHEMICALLY REACTIVE MATERIAL

(75) Inventor: Wei-Jun Zhang, Mason, OH (US)

(73) Assignee: Empire Technology Development LLC, Wilmington, DE (US)

(21) Appl. No.: 13/322,801

(22) PCT Filed: May 3, 2011
(86) PCT No.: PCT/US11/34938

§ 371 Date: Nov. 28, 2011

Related U.S. Application Data
(60) Provisional application No. 61/343,696, filed on May 3, 2010.

(51) Int. Cl. C25C 1/00; C25C 1/24; C25C 7/06; B82Y 40/00; B82Y 99/00

(52) U.S. Cl. 205/557; 205/560; 204/275.1; 977/773; 977/899

(57) ABSTRACT

A method and apparatus for producing particles from a starting material, which includes at least one electrochemically-reactive material, with metal counter ions is disclosed. The starting material can be a bulk material, a virgin material, a purified, recovered material, and/or an industrial waste. The electrochemical-reactive material can be recovered in particle form, including microparticles and/or nanoparticles. The recovered material can be substantially pure electrochemically-reactive material or an alloy of the electrochemically-reactive material. In some embodiments, one or more electrochemically-reactive materials can be selectively recovered from the starting material.

### CROSS-REFERENCE TO RELATED APPLICATIONS

This application claims the benefit of and priority to U.S. Provisional Patent Application No. 61/343,696, entitled “Fine Grained Materials Prepared by Electrochemically Grain Refinement Process,” naming Wei-Jun Zhang as the inventor, filed May 3, 2010, which is hereby incorporated by reference.

### BACKGROUND

Every year, millions of tons of industrial wastes are generated worldwide due to the manufacturing and disposal of electronics (e.g., consumer electronics, photovoltaic cells, semiconductors, etc.), batteries, catalytic converters, and industrial scraps. Current methods of recycling and recovering materials from industrial wastes are based on processes that rely on strong, corrosive and/or toxic bases or acids (e.g., to dissolve the target material(s)). For example, processes using hydrofluoric acid, nitric acid, hexafluorosilic acid, or sodium hydroxide are known in the art. Processes using these types of chemicals are expensive, environmentally-unfriendly, and potentially hazardous. As a result, only a small percentage of industrial waste is recycled each year.

The use of micro- and nanoparticles has become of increased importance due to the unique properties of these materials, such as their physical mechanical, chemical, and/or biological properties. For example, micro- and nanoparticles can have enhanced yield strength and ductility compared to a bulk material of the same composition due to their refined grain sizes (e.g., less than about 100 nanometers). Materials having these properties can be used in the medical, chemical, energy, and/or transportation sectors. Many approaches are known in the art to prepare micro- and nanograined materials, such as chemical or physical vapor deposition, severe plastic deformation, rapid solidification, and wet chemical methods. However, these approaches suffer from being energy intensive, environmentally unfriendly, having a high manufacturing cost, a low production rate, a high concentration of impurities in the recovered product, and/or difficulty in scaling up to an industrial scale.

Accordingly, it would be highly desirable to reduce industrial wastes by developing an inexpensive and environmentally-friendly process to recycle industrial waste materials. Further, it would be highly desirable to produce micro- and/or nanoparticles particles in an inexpensive and environmentally-friendly manner at a commercial scale.

### SUMMARY

In some embodiments, a method for forming particles or nano-grains includes connecting a starting material as a first electrode in a circuit that includes the first electrode and a counter electrode each of which is at least partially disposed in an electrolyte. The electrolyte includes metal counter ions, the counter electrode includes a source of the metal counter ions, and the starting material includes at least one electrochemically reactive material which is electrochemically reactive to the metal counter ions. The method includes applying a first voltage between the first electrode and the counter electrode to ionize the source of metal counter ions to yield the metal counter ions. At least some of the metal counter ions react with the at least one electrochemically reactive material in the first electrode to form a metal-electrochemically reactive material compound. The method further includes applying a second voltage of opposite polarity to the first voltage to ionize the metal counter ions from the metal-electrochemically reactive material compound to recharge the counter electrode, thereby producing particles of the electrochemically reactive material. In some embodiments, the method includes repeating the application of the first and second voltages to produce particles (e.g., micro- and/or nanoparticles).

In some embodiments, a method for forming nanoparticles includes connecting a starting material as a first electrode in a circuit that includes the first electrode and a counter electrode each of which is at least partially disposed in an electrolyte. The electrolyte includes lithium counter ions (Li⁺), the counter electrode includes a lithium metal or lithium-containing material (e.g., an alloy, compound, mixture, etc.) as a source of the lithium counter ions (Li⁺), and the starting material includes M, wherein M is at least one electrochemically reactive material selected from Si, Ga, Ge, Pt, Ag, Au, In, Sn, Al, Zn, Sb, Cd, As, Pb, Mg and combinations thereof. The method includes applying a first voltage between about 0.01V to about 20V, between the first electrode and the counter electrode to ionize the source of lithium counter ions to yield the lithium counter ions. At least some of the lithium counter ions react with the at least one electrochemically reactive material in the first electrode to form a LiₓM_{y} compound, wherein LiₓM_{y} represents a compound exhibiting at least about a 20% change in unit volume compared to a compound of the starting material that includes the electrochemically reactive material. The method further includes applying a second voltage of opposite polarity to the first voltage to ionize the Li counter ion from the LiₓM_{y} compound, thereby producing substantially purified and pulverized particles of M. In some embodiments, the particles of M form after one or more cycles of applying the first and second voltages.

In some embodiments, an apparatus for generating nanoparticles includes an electrical circuit that includes a first electrode, a counter electrode, and an electrolyte. The first electrode includes a porous, non-reactive container for housing at least one electrochemically reactive material which is electrically coupled as at least a portion of the first electrode. The counter electrode includes a source of metal counter ions. The electrolyte includes the metal counter ions. The first electrode and the counter electrode are electrically coupled to one another for applying a voltage therebetween. Each of the first electrode and the counter electrode are at least partially disposed within the electrolyte

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is an illustrative embodiment of an apparatus for generating particles.

FIG. 2 is an illustrative embodiment of a container that can be included in an apparatus for generating particles.

FIG. 3 shows an example flow diagram of a method for forming particles.

### DETAILED DESCRIPTION

In general, in some embodiments herein, the present disclosure is believed to exploit an electrochemical reaction that occurs between a starting material (e.g., a first electrode) that includes an electrochemically-reactive material, ERM, (e.g., Si) and a source of metal counter ions (e.g., Li⁺) (e.g., a second electrode), upon the application of a first voltage, to form a metal-ERM compound. Further, the present disclosure exploits the fact that the metal-ERM compound has a unit volume at least about 20% greater than a unit volume of the electrochemically reactive material present in the starting material. Further, the present disclosure exploits the fact that the electrochemical reaction can be reversed by applying a second voltage having an opposite polarity to the first voltage. The application of the second voltage results in the metal-ERM compound decomposing into the metal counter ions and particles of the electrochemically reactive material. In some embodiments, particles form after one or more cycles of applying the first and second voltages. These particles can be separated and collected or left for further reaction. The voltage cycling results in pulverization of the electrochemically reactive material.

Without wishing to be bound by any theory, it is believed that the volume change that results from the formation and deformation of the metal-ERM compound causes stress (e.g., internal stress) in the electrochemically reactive material. The stress and limited diffusion rate can cause the electrochemically reactive material to form particles or fine grains thereof (e.g., to pulverize). The formed particles or grains can include alloys or substantially pure electrochemically reactive materials (e.g., about 99% pure Si) that can be used commercially in various industries, including the medical, chemical, energy, and/or transportation sectors.

The starting electrochemically reactive material can be found in industrial waste (e.g., consumer electronics, photovoltaic cells, semiconductors, etc.) and/or in a bulk, virgin, or a purified, recovered material. As such, the formation of particles can be an inexpensive, environmentally-friendly, and scalable method for recycling (e.g., recovering) industrial waste and/or for forming micro- or nanoparticles or grains either from waste material, new material, or previously recovered material. We now turn to the figures for a more complete understanding of exemplary embodiments of the invention. The drawing figures are meant to be illustrative in nature and are not intended to limit the invention.

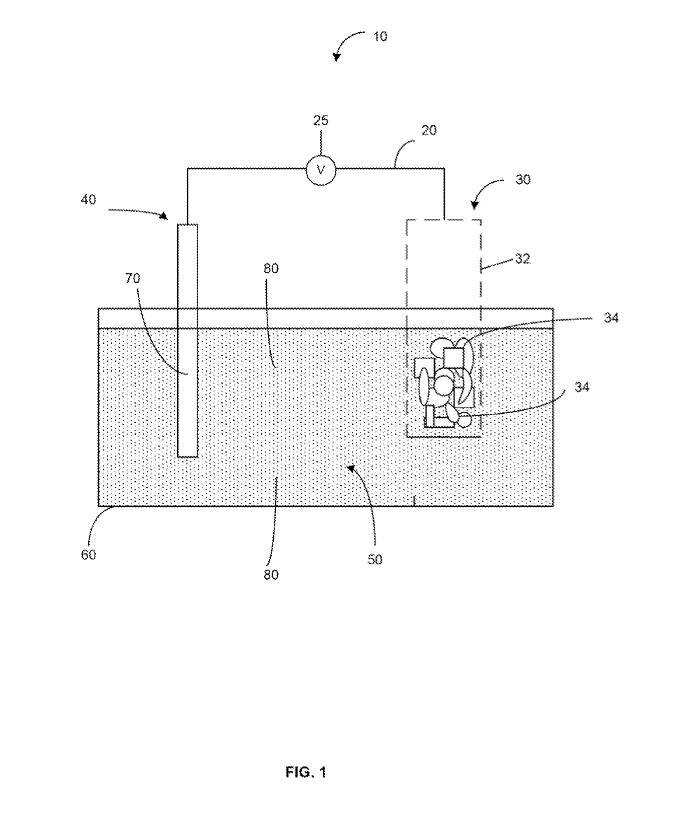

FIG. 1 is an illustrative embodiment of an apparatus for forming particles. As shown in FIG. 1, an apparatus 10 includes an electrical circuit having a first electrode 30, a counter electrode 40, and an electrolyte 50. The first electrode 30 and the counter electrode 40 are electrically coupled to one another in the electrical circuit via a wire 20, for example, to apply a voltage therebetween. The first electrode 30 and the counter electrode 40 are at least partially disposed in the electrolyte 50, which can be disposed in a non-reactive chamber 60.

In some embodiments, the first electrode 30 includes a container 32 that can house a starting material 34. The container 32 can have pores, apertures, holes or similar features to allow the electrolyte 50 to penetrate a wall of the container 32 to contact the starting material 34. The starting material can be electrically coupled (e.g., via contact with a portion of the container 32, or a separate direct connection to the wire 20) as at least a portion of the first electrode 30. Regardless of how it is accomplished, the ERM in the starting material is coupled as at least a portion of the first electrode 30 in the circuit. The starting material 34 includes at least one electrochemically reactive material (e.g., Si) that can electrochemically react with metal counter ions (e.g., Li⁺) to form a metal-ERM compound (e.g., Li₁₅Si₄), as discussed below. In some embodiments, the at least one electrochemically reactive material includes Si, Ga, Ge, Pt, Ag, Au, In, Sn, Al, Zn, Sb, Cd, As, Pb, Mg, and/or combinations thereof. In some embodiments, the at least one electrochemically reactive material is electrochemically reactive to Li, Na, K, Mg, salts, and ions thereof.

The starting material 34 can include waste material or substantially pure material. The waste material can be from electronics (e.g., consumer electronics, photovoltaic cells, semiconductors, etc.), batteries, catalytic converters, industrial scraps, or other wastes that include one or more electrochemically reactive materials. For example, waste from electronics can include the following electrochemically reactive materials: Si, Ga, Ge, Ag, Au, In, Sn, Al, Zn, Sb, Cd (e.g., from CdTe-based photovoltaic cells), As, Pb, Mg. For example, batteries can include Cd (e.g., from a Ni-Cd battery) or Pb as an electrochemically reactive material. Catalytic converters can include Pt as an electrochemically reactive material. Industrial scraps can include Al, Mg, Pb, Sb as electrochemically reactive materials. The substantially pure material can include virgin, bulk, or reclaimed materials and can have a concentration of greater than about 70%, greater than about 80%, greater than about 90%, greater than about 95%, greater than about 99%, or greater than about 99.9% of the electrochemically reactive material (e.g., greater than about 99% Si), or ranges between any two of these values. Particularly, bulk, virgin, substantially pure, or recovered materials comprising Si, Ga, Ge, Pt, Ag, Au, In, Sn, Al, Zn, Sb, Cd, As, Pb, Mg, and/or combinations thereof can be used as starting material. In some embodiments, virgin material is a substantially pure material that has not been incorporated into a product or mixed, reacted, or combined with other materials. For example, virgin material can be a substantially pure piece of silicon (e.g., amorphous, crystalline, semi-crystalline, etc.), or other electrochemically reactive material. Reclaimed material can be electrochemically reactive material that has been recycled after at least one prior use.

The counter electrode 40 includes a source 70 of metal counter ions 80. The source 70 creates the metal counter ions 80 when a voltage is applied between the first electrode 30 and the counter electrode 40 through the circuit 20. The metal counter ions 80 can include Li⁺, Na⁺, K⁺, Mg²⁺, or combinations thereof. The source 70 is a material containing metal (e.g., Li metal, Na metal, K metal, Mg metal or their compounds) that can form the metal counter ions. For example, in some embodiments, the metal counter ions 80 include Li⁺ and the source 70 includes Li metal, LiFePO₄, LiCoO₂, Li₄Ti₅O₁₂, LiMn₂O₄, Li—Al, Li—Sb, Li—Sn, or combinations thereof. In some embodiments, the metal counter ions 80 include Na⁺ and the source 70 includes NaCl, NaBr, Na₃P, Na₂CO₃, NaHCO₃, NaI, or combinations thereof. In some embodiments, the metal counter ions 80 includes Mg²⁺ and the source 70 includes MgSO₄, MgCl₂, or combinations thereof. In some embodiments, the metal counter ions 80 include K⁺ and the source 70 includes KCl, KBr, KI, KBrO₃, Na₃P, K₂CO₃, K₂CO₃, or combinations thereof.

The electrolyte 50 includes a liquid and the metal counter ions 80. The electrolyte 50 can be aqueous, non-aqueous (e.g., an organic solvent), or a combination of aqueous and non-aqueous solvents. The counter ions 80 can be in solution, a suspension, a dispersion, a mixture, or any other combination with the liquid. The metal counter ions 80 can include K⁺, Li⁺, Na⁺, Mg²⁺, or combinations thereof, as discussed above. In some embodiments, a salt that includes the metal counter ions 80 (e.g., one or more of the salts described above) is included in the liquid to form the electrolyte 50. The organic solvent can include one or more of the following general classes of organic solvents: ether, ester, carbonate, ketone, alcohol, sulfonate, and aromatic solvents. The liquid can include one or more of the following specific examples of organic solvents: propylene carbonate, ethylene carbonate, ethyl carbonate (EC), diethyl carbonate (DEC), dimethyl carbonate, 1,2-dimethoxyethane, diethylene glycol dimethyl ether, diethylene glycol diethyl ether, diethylene glycol dibutyl ether, dipropylene glycol dimethyl ether, diethoxyethane, BEE-1-tert-butoxy-2-ethoxyethane and mixtures thereof. For example, the apparatus 10 can include LiFePO₄ as the source 70 (to produce Li⁺ as the metal counter ions 80) and the electrolyte 50 can include LiPF₆ in a concentration of 1 mol/L combined (e.g., dissolved) with ethyl carbonate, diethyl carbonate, and dimethyl carbonate in a volume ratio of about 1:1:1.

In some embodiments, the liquid includes water or a water-based solution. When water or a water-based solution is used, special precautions may be taken when using the pure metal as the source of counter ions, and also upon formation/deformation of the metal-ERM compound at the first electrode. For example, when using Li metal at the counter electrode 40, the Li metal may be protected from direct contact with the water or water-based solution to minimize a reaction between water and Li metal. Those of skill in the art will readily appreciate techniques for protecting the counter electrode 40 from such reactions. For example, the electrode 40 may be protected by a non-reactive polymer or ceramic coating, which would allow the ionized metal to pass into and out of the electrolyte without reacting with water. Similar precautions could be taken at the first electrode 30.

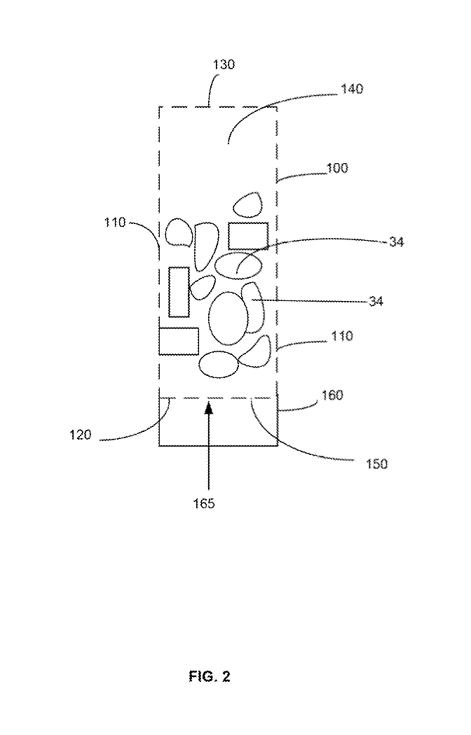

In some embodiments, the container 32 is a porous, non-reactive container 100, as depicted in FIG. 2. The container 100 includes sidewalls 110, a bottom wall 120, and a top wall 130. In some embodiments, the container 100 is part of the first electrode and carries current through its sidewalls 110 and into the starting material 34. In some embodiments, the container 100 is merely a holding vessel, with current carried directly to the starting material 34 via a wire (e.g,. the wire 20) or similar component (not shown). The former embodiment is described further. The container 100 can house the starting material 34, which can be electrically coupled (e.g., in contact) with one or more of the sidewalls 110, the bottom wall 120, or the top wall 130. The top wall 130 can be removable to allow an operator access to an interior 140 of the container 100 (e.g., for adding or removing the starting material 34). The sidewalls 110 can include pores, gaps, channels, passageways, holes, apertures or similar features pores or similar features to allow the electrolyte 50 to contact the starting material 34 housed in the container 100.

The bottom wall 120 can include optional apertures 150 to allow particles to pass through while retaining the starting material 34. The apertures 150 can include gaps, channels, passageways, holes, pores or similar features. The apertures 150 can be adapted to allow particles less than or equal to a desired size (e.g., 100 μm or less, 10 μm or less, 1 μm or less, 100 nm or less) to pass through. In some embodiments at least one of the sidewalls 110 or the bottom wall 120 includes a mesh or screen material. Particles passing through the apertures 150 can be collected in an optional second container 160 having an open side 165 below the apertures 150. The container 100 can be formed out of stainless steel, nickel, copper or similar materials that are not reactive or electrochemically reactive with the metal counter ions 80. The container 100 can be conductive or semi-conductive and can be electrically coupled to the starting material 34 as at least a portion of the first electrode 30. An agitator (not shown) can be connected to the container 100 to shake, vibrate, or otherwise agitate particles in the container 100 to direct the particles through the apertures 150 for collection in the second container 160. The second container 160, can be electrically conductive or non-conductive. In conductive arrangements, any particles collected in the second container 160 may be further pulverized similar to the ERM in the first electrode. In non-conductive arrangements, particles having passed through to the second container 160, will have met the desired size requirement, passing through the apertures 165, and will not be electrically coupled to the first electrode 30, and therefore will not be subjected to further electrochemical reaction or pulverization. In either case, the particles collected in the second container 160, can be separated by simply removing them from the second container. When a second container is not used, the formed particles may simple fall to the floor of the chamber 60 or the bottom wall 120 of the container 100, and collected later.

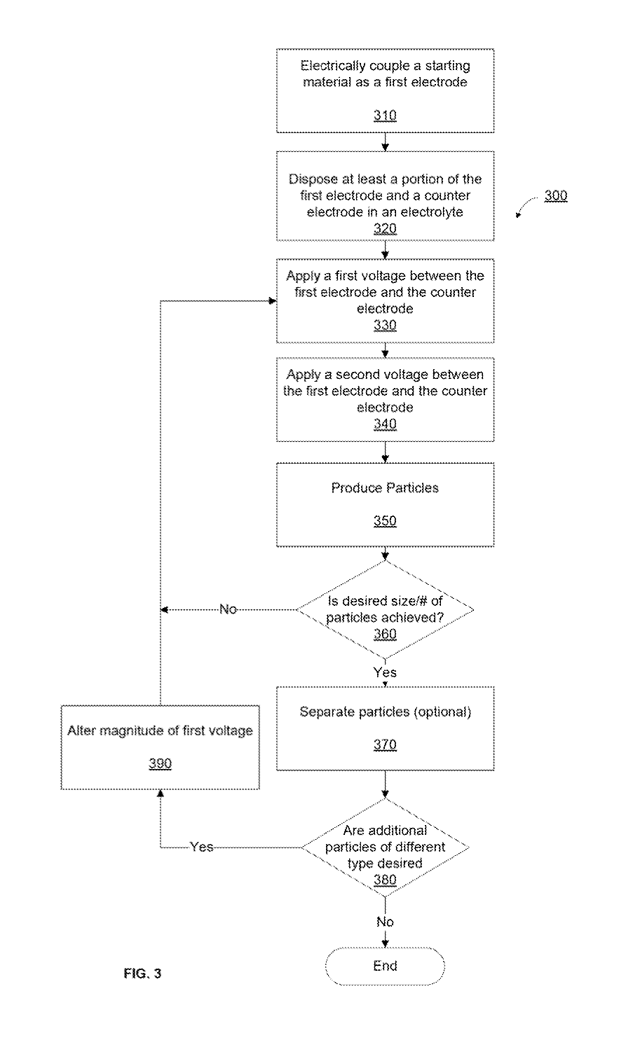

Some embodiments provide methods for forming particles. In some embodiments, the apparatus 10 as shown in FIG. 1 or a similar apparatus can be used in a method to form particles, as depicted in the flow chart in FIG. 3. In some embodiments, such an apparatus is provided such as that depicted in FIG. 1 is provided to which starting material 34 is added.

A method 300 of forming particles includes electrically coupling a starting material as a first electrode (step 310); disposing at least a portion of the first electrode in the electrolyte (step 320); applying a first voltage between the first electrode and the counter electrode (step 330); applying a second voltage between the first electrode and the counter electrode (step 340); and producing particles (step 350).

In the coupling step, 310, the starting material 34 can be electrically coupled as the first electrode 30 to form the circuit with the counter electrode 40, step 310. The circuit can also include the container 32 or 100, which can house and be electrically coupled with the starting material 34, as described above. The wire 20 or other conductive material can be electrically coupled with the first electrode 30, the counter electrode 40, and a voltage source 25 to form the circuit. The counter electrode 40 can include the source 70 of the metal counter ions 80 (e.g., Li⁺, Na⁺, K⁺, Mg²⁺), as discussed above. In some embodiments, a coating on the starting material 34 can be scratched or removed to allow the electrolyte 50 to contact exposed electrochemically reactive materials that were covered by the coating.

At least a portion of the first electrode 30 and the counter electrode 40 are disposed in the electrolyte 50, as shown in step 320. The electrolyte 50 can be between about 20° C. to about 60° C., 30° C. to about 50° C., about 30° C. to about 40° C., about 40° C. to about 50° C., about 50° C. to about 60° C., about 20° C. to about 30° C. In some embodiments the electrolyte can be maintained at about 20° C., about 25° C., about 35° C., about 45° C., about 55° C., about 60° C. or ranges between any two of these values. In some embodiments, the apparatus 100 includes the chamber 60 that can house the first electrode 30, the counter electrode 40, the electrolyte 50, the conductive wire 20, and the voltage source 25, as discussed above. The first electrode 30 comprises the starting material 34. In some embodiments, the first electrode 30 is starting material 34 coupled to the counter electrode 40. In other embodiments, the first electrode 30 comprises a conductive cage or other member which houses and contacts the starting material 34, and more specifically, contacts and electrically couples the ERM which acts as the first electrode 34. The electrolyte 50 includes a combination of the metal counter ions 80 and an aqueous, non-aqueous, or organic liquid, as discussed above. Step 320 can occur before or after step 310.

A first voltage is applied (e.g., by the voltage source 25) between the first electrode 30 and the counter electrode 40 (e.g., through the circuit 20), as depicted in step 330. The voltage can be a DC voltage and can be greater than or equal to a reaction voltage (i.e., reaction potential) of one or more electrochemically reactive materials in the starting material 34. The reaction voltage is the voltage at which the electrochemical reactive material and the metal counter ions 80 electrochemically react. For example, the first voltage can be between about 0.01V to about 20 V, about 0.1V to about 19 V, about 1V to about 15V, about 5V to about 10V, 7V, about 0.1V to about 3.4V, about 0.4V to about 1.6V, or about 0.6 to about 0.9V. Specific examples of the first voltage include about 0.01, about 0.1, about 0.3, about 0.4, about 0.6, about 0.9, about 1, about 3.4, about 5, about 10, about 19, about 20 volts and ranges between any two of these values.

The first voltage causes the source of metal ions 70 at the counter electrode 40 to ionize, thereby yielding the metal counter ions 80 (e.g., Li⁺). The metal counter ions 80 (e.g., ionized from the source 70 and/or included in the electrolyte 50) electrochemically react with at least one electrochemically reactive material that is included in the starting material 34 at the first electrode 30 to form a metal-ERM compound. For example the first voltage (e.g., about 3.4 V to about 4.0 V) can cause LiFePO₄ (source 70) to ionize into Li⁺ (metal counter ions 80). Li⁺ can electrochemically react with an electrochemically reactive material M to form a lithium-electrochemically reactive material compound LiₓM_{y}. For example, the electrochemically reactive material can include Si and the LiₓM_{y} compound can be Li₁₅Si₄.

The metal-ERM compound can have a unit volume at least about 20% greater than a unit volume of the electrochemically reactive material as found in the starting material 34. In some embodiments, the change in volume may have minimal or no effect on the volume of the first electrode as a whole. In some embodiments, the metal-ERM compound has a unit volume between about 20% to about 400%, about 50% to about 350%, about 100% to about 300%, about 150% to about 250%, or about 200% greater than a unit volume of the electrochemically reactive material as found in the starting material 34. For example, Li and Si can react to form Li₁₅Si₄ or Li₂₂Si₅, which can have a unit volume up to about 320% greater than a unit volume of the starting material 34 that includes Si.

A second voltage having an opposite polarity to the first voltage can then be applied to the electrical circuit (e.g., via the wire 20) between the first electrode 30 and the counter electrode 40, as depicted in step 340. The second voltage can have the same or a different magnitude than the first voltage. The second voltage ionizes (e.g., dissassociates) the metal-ERM compound to re-form at least some of the metal counter ions 80, thereby returning at least a portion of the metal-ERM compound to pulverized and purified electrochemically reactive material. For example, the second voltage can dissassociate the LiₓM_{y} compound described above to produce substantially purified and pulverized particles of M (e.g., after cycling between applying the first and second voltages); the Li ions move back into the counter electrode 40, thus recharging the counter electrode 40 for a subsequent application. In another example, the second voltage can decompose Li₁₅Si₄ to produce substantially purified and pulverized particles of Si. The metal counter ions 80 (e.g., Li⁺) can return to the electrolyte 50 and/or the source 70 and can recharge the counter electrode 40. In doing so, the electrochemically reactive material undergoes a reduction in unit volume. The reduction in unit volume can cause stress (e.g., an internal stress) in the electrochemically reactive material that can cause the electrochemically reactive material to pulverize into particles or grains thereof, as depicted in step 350. In some embodiments, the particles or grains can be micro-particles or grains or nanoparticles or grains, or a combination thereof. The process is not unlike the result that the freezing and thawing action of water has in breaking down rocks. If the electrolyte 50 includes an aqueous liquid, a coating can be applied to the source 70 to prevent water and the source from electrochemically reacting (for example, water can react with Li).

TABLE 1
Summary of physical properties of certain
electrochemically reactive materials.

| Electrochemically | | | | | | |
|---|---|---|---|---|---|---|
| reactive material | i | Sn | Sb | l | [symbol] g | [symbol] i |
| Density (g/cm³) | .33 | 7.29 | 6.7 | .7 | 1.3 | [symbol] .78 |
| Average volume | 20 | 260 | 200 | 6 | 100 | [symbol] 15 |
| change (%) (when | | | | | | |
| reacting with Li⁺) | | | | | | |
| Reaction | .4 | 0.6 | 0.9 | .3 | 0.1 | [symbol] .8 |
| Potential vs. Li (~V) | | | | | | |

[symbol]

indicates data missing or illegible when filed

With reference to Table 1, a reaction voltage (i.e., a first voltage) of about 0.4V is required to electrochemically react Li⁺ (i.e., the metal counter ions 80) with Si (i.e., the electrochemically reactive material). The reaction voltage of 0.4V is also sufficient to electrochemically react Li⁺ with Al (0.3V) and Mg (0.1V). Accordingly, if the first voltage is at least 0.4V, Li⁺ can electrochemically react with Al, Mg, and/or Si if one or more of Al, Mg, and/or Si are included in the starting material 34. Accordingly, the resultant particles will be particles of Al, Mg, and/or Si, depending upon their presence in the starting material.

Table 1 also discloses that a unit volume of a Si—Li compound (e.g., Li₁₅Si₄ or Li₂₂Si₅) can be up to 320% greater than a unit volume of Si in the starting material 34. Additionally, a unit volume of an Al—Li compound can be up to 96% greater than a unit volume of Al in the starting material 34. Further, a unit volume of a Mg—Li compound can be up to 100% greater than a unit volume of Mg in the starting material 34. This change in unit volume can cause internal stress that can result in the formation of particles of one or more electrochemically reactive materials, for example, due to the high internal stress and the limited diffusion rate at a low operation temperature (e.g., about 25° C.). In some embodiments, the metal counter ions 80 can be Mg²⁺ and/or Na⁺ and the electrolyte 50 can be between about 25° C. to about 100° C., or about 30° C., about 40° C., about 50° C., about 60° C., about 70° C., about 80° C., about 90° C., about 100° C. or ranges between any two of these temperatures. In some embodiments, the electrochemical reactive materials have a concentration of at least about 30% in the starting material 34.

The particle size and/or volume of particles can be controlled by cycling through steps 320, 330, and 340 one or more additional times, as depicted in step 360. For example, a median particle size after a first cycle can be about 1-10 mm, about 1-100 μm after a second cycle, and about 1-100 nm after a third cycle. In some embodiments, nanoparticles are formed in about 1-10 cycles, 3-7 cycles, 4-6 cycles, or 5 cycles. The number of cycles can generally be any number. Specific examples of the number of cycles include about 1, about 2, about 3, about 4, about 5, about 6, about 7, about 8, about 9, about 10, about 11, about 12, about 13, about 14, about 15, about 16, about 17, about 18, about 19, about 20, and ranges between any two of these values. In some embodiments, the magnitude of the first and/or the second voltage can be the same or different in each cycle.

After a desired number of cycles, the particles can optionally be separated from the starting material, as depicted in step 370. In some embodiments, the particles can be separated by passing the particles through the apertures 150 of the container 100 depicted in FIG. 2 or by other known separation methods. The container 100 can be agitated, vibrated, shaked, etc. to promote the separation of the particles from the starting material 34 (e.g., by passing the particles through the apertures 150). In some embodiments, the particles can be collected in a container (e.g., the container 160 in FIG. 2).

In some embodiments, the particles formed in step 350 can include an alloy that includes at least one electrochemically reactive material and at least a portion of the starting material 34. For example, the starting material 34 can include TiAl₃. The particles that result after steps 330, 340, and 350 can include Ti and Al, for example, as dual-phased micro- or nanoparticles or grains. Materials with such dual-phase nanograins or nanoparticles of such an alloy can have enhanced mechanical and/or physical properties (e.g., an exceptional combination of strength and/or ductility). In some embodiments, the alloy can include the metal counter ions 80 (e.g., Li⁺). For example, the process can form a dual-phased (Al+AlLi) fine grained surface layer on an Al sheet or bulk Al material), for example, by eliminating or reducing the application of the second voltage (step 340) so that at least a portion of the metal counter ions 80 remain in the metal-electrochemical reactive material compound. These dual-phase particles or bulk materials can have enhanced mechanical and/or physical properties. For example, alloys made of Ti and Al or Al and LiAl nanoparticles or nanograins are light-weight and high-strength materials that can be used in the aerospace or automotive industries. An alloy that includes particles of Fe and Si can form an electrical steel. An alloy that includes Cu and Sn can form a wear-resistant and thermally and/or electrically conductive material. In some embodiments, the particles can be formed in a surface layer of a bulk material (e.g., a sheet or film) to produce a micro- or nano-grained surface. The insertion of the metal counter ions 80 into the surface layer (i.e,. step 330) can cause a compressive force on the bulk material. Such bulk materials can have enhanced mechanical and/or physical properties, such as enhanced wear and/or fatigue resistance.

In some embodiments, the electrochemically reactive material can be selectively recovered from the source material. For example, a first electrochemically reactive material can be recovered by applying a first voltage (step 330) at a first magnitude followed by a second voltage (step 340) to selectively recover particles (step 350). The first magnitude can be greater than or equal to a reaction voltage (e.g., reaction potential) of the first electrochemically reactive material but less than a reaction voltage of a second electrochemically reactive material. The first magnitude of the first voltage can cause the metal counter ions 80 to react with the first electrochemically reactive material to form a metal-first electrochemically reactive material compound. The metal counter ions 80 do not react with the second electrochemically reactive material because the first magnitude is less than the reaction voltage of the second electrochemically reactive material. For example, the electrochemical reaction voltage of Li with Si is about 0.4V and Li with Sb is about 0.9V, as shown in Table 1. Accordingly, to selectively recover particles of Si by an electrochemical reaction with Li, the first magnitude of the first reaction can be greater than or equal to 0.4V but less than 0.9V. Li does not react with Sb because the first magnitude is less than the reaction voltage needed for electrochemically reacting Li with Sb (0.9V).

Further recovery or pulverization of the first electrochemically reactive material can occur by cycling through steps 330, 340, and 350 one or more times (e.g., step 360) where the magnitude of each first voltage cycle (step 330) is greater than or equal to the reaction voltage of the first electrochemically reactive material but less than the reaction voltage of the second electrochemically reactive material (i.e., the first magnitude can be the same or different during each cycle). Optionally, particles or grains of the first electrochemically reactive material can be separated from the starting material (step 370), for example, by agitation, as discussed above.

If recovery of a second electrochemically reactive material is desired (step 380), the magnitude of the first voltage can be altered (step 390) to a second magnitude that is greater than or equal to the reaction voltage of the second electrochemically reactive material. In some embodiments, the second magnitude is greater than the first magnitude. For example, the reaction voltage of Li with Sb is 0.9V, as shown in Table 1. Accordingly, the second magnitude of the first voltage can be altered to at least 0.9V to selectively recover Li with Sb. Optionally, the second magnitude can be greater than or equal to the reaction voltage of the second electrochemically reactive material and less than a reaction voltage of a third electrochemically reactive material, if three or more electrochemically reactive materials are included in the starting material 34. The second magnitude of the first voltage can cause the metal counter ions 80 to react with the second electrochemically reactive material to form a metal-first electrochemically reactive material compound. The metal counter ions 80 do not react with the first electrochemically reactive material, which has previously been recovered (or at least substantially recovered) from the starting material 34. Optionally, the metal counter ions 80 do not react with the third electrochemically reactive material because the second magnitude can be less than the reaction potential of the third electrochemically reactive material.

Further recovery or pulverization of the second electrochemically reactive material can occur by cycling between steps 330, 340, and 350 one or more times (e.g., step 360) where the magnitude of each first voltage cycle (step 330) is greater than or equal to the reaction voltage of the second electrochemically reactive material and, optionally, less than the reaction voltage of the third electrochemically reactive material (i.e., the second magnitude can be the same or different during each cycle). Optionally, particles or grains of the first electrochemically reactive material can be separated from the starting material (step 370), for example, by agitation, as discussed above.

Optionally, additional electrochemically reactive materials can be selectively recovered by continuing the cycle of altering the magnitude of the first voltage (step 390) and then applying the first and second voltages to produce particles or grains (steps 330, 340, and 350) of a selected electrochemically reactive material. By selecting the first voltage, the type of electrochemically reactive material being pulverized may be selected. For example, by starting at the lowest voltage and progressively getting larger, you can separate out individual materials. For example, starting at 0.1V, one can separate out Mg, to the exclusion of the other electrochemically reactive materials. Once sufficient Mg has been pulverized and separated, it can optionally be removed. The voltage may then be increased to, e.g., 0.3V to separate out Al. The process can continue until all electrochemically reactive materials are removed.

For example, Si and Sn can each be selectively recovered from a starting material 34 (e.g., industrial waste) in the following process using, for example, Li as the source 70 of metal counter ions 80 (i.e., Li⁺). First, Si can be recovered by applying a first voltage (step 330) at a first magnitude that is greater than or equal to the reaction potential of Si (0.4V) and less than the reaction potential of Sn (0.6V), for example 0.5V. The first voltage at the first magnitude of 0.5V causes Li⁺ and Si to electrochemically react to form a Li—Si compound (e.g., Li₁₅Si₄ or Li₂₂Si₅) having a unit volume up to 320% greater than a unit volume of Si in the starting material 34 (e.g., SiO₂). Li⁺ does not react with Sn because the first magnitude of the first voltage (0.5V) is less than the reaction voltage of Sn (0.6V). An opposite voltage (i.e., the second voltage in step 340) can then be applied to decompose the Si—Li compound into Li⁺ metal counter ions 80 and Si, thereby forming Si particles or grains (step 350). Optionally, the Si particles or grains can be separated (step 370) or further recovered or pulverized (step 360).

Second, Sn can be selectively recovered by altering (e.g., increasing) the first voltage to a second magnitude (step 380) that is greater than or equal to 0.6V, for example at 0.7V. Applying the first voltage at 0.7V (step 330) causes Li⁺ to react with Sn to form a Li—Sn compound (e.g., Li₂Sn₅, Li₇Sn₂, etc.) having a unit volume up to about 260% greater than a unit volume of Sn in the starting material 34). An opposite voltage (i.e., the second voltage in step 340) can then be applied to decompose the Sn-Li compound, thereby forming Li⁺ metal counter ions 80 and Sn, thereby forming Sn particles or grains (step 350). Optionally, the Sn particles or grains can be separated (step 370) or further pulverized (step 360).

The following examples are merely illustrative and are not intended to limit the scope and spirit of the invention.

### EXAMPLE 1

### Formation of Silicon Nanoparticles from Scraps of Semiconductor Chips Using Lithium Ions

A solution of ethyl carbonate, diethyl carbonate, and dimethyl carbonate in a volume ratio of 1:1:1 can be prepared in a chamber at 25° C. LiBF₄ salt can be added at a concentration of 1.0 mol/L to the solution to form a dissolved solution. A scrap piece of a semiconductor chip that includes silicon, of about 1-10 grams, can be placed into a non-reactive, electrically-conductive container to form a first electrode. A conventional porous LiFePO₄ battery electrode (with carbon black) can be connected as a counter electrode. The first electrode and the counter electrode can be partially submerged in the dissolved solution. The first electrode and the counter electrode can be connected by a wire, which also can be connected to a voltage source.

Using the voltage source, a positive voltage of about +3.0V can be applied between the first electrode and the counter electrode until the electrochemical reaction stops (e.g., the electric current between the first and second electrodes can be close to zero). Next, a negative voltage of about −3.0 V can be applied until the reaction stops (e.g., the electric current between the first and second electrodes can be close to zero). The cycle of applying a positive voltage of +3.0V and a negative voltage of about −3.0V can be repeated for a total of three to ten cycles, or any number of cycles therebetween. High purity Si (e.g., greater than about 95% pure Si) nanoparticles can be produced from the semiconductor chips. Nanoparticles of silicon can be observed at the bottom of the container. The purity of the Si can be measured using standard analytical techniques.

### EXAMPLE 2

### Selective Recovery Silicon and Antimony Using Lithium Ions

A solution of lithium bis(oxatlato)borate (“LiBOB”) salt at a concentration of 1.25 mol/L in 1,2-dimethoxyethane can be prepared in a chamber at a temperature of about 25° C. A scrap piece of a photovoltaic cell that includes silicon and antimony can be placed into a porous, non-reactive, and electrically-conductive container (first container) to form a first electrode. The first container can include apertures in a bottom surface and second container can be disposed beneath the apertures. A FeLiPO₄ battery electrode can be used as a counter electrode. The first electrode and the counter electrode can be partially submerged in the LiBOB and 1,2-dimethoxyethane solution. The first electrode and the counter electrode can be connected by a wire, which can also be connected to a voltage source. An agitator can be connected to the first container.

Using the voltage source, a positive voltage of about +2.8 V can be applied between the first electrode and the counter electrode until the electrochemical reaction ceases (e.g., the electric current between the first and second electrodes can be close to zero). Next, a negative voltage of about −2.8 V can be applied between the first electrode and the counter electrode until the electrochemical reaction ceases (e.g., the electric current between the first and second electrodes can be close to zero). The cycle of applying a positive voltage of about +2.8V and a negative voltage of about −2.8V can be repeated for about two to about fifteen times, or any number of repetitions therebetween. The agitator can shake and vibrate the first container to cause particles of silicon to pass through the apertures and collect in the second container. The second container can be removed to recover the silicon nanoparticles.

After replacing the second container, a positive voltage of about +2.5V can be applied between the first electrode and the counter electrode until the reaction ceases (e.g., the electric current between the first and second electrodes can be close to zero). Next, a negative voltage of about −2.5V can be applied between the first electrode and the counter electrode until the reaction ceases (e.g., the electric current between the first and second electrodes can be close to zero). The cycle of applying a positive voltage of about +2.5V and a negative voltage of about −2.5V can be repeated for about two to fifteen times, or any number of repetitions therebetween. The produced antimony nanoparticles can be separated from the container. The purity of the recovered silicon and/or antimony can be measured using standard analytical techniques.

### EXAMPLE 3

### Formation of an Alloy of Titanium, Aluminum and Lithium

A solution of LiBF₄ salt at a concentration of 1.0 mol/L in diethylene glycol can be prepared in a chamber at a temperature of about 30° C. A 25 g sample of a TiAl₃ powder can be placed into a porous, non-reactive, and electrically-conductive container (first container) to form a first electrode. A Li₄Ti₅O₁₂ electrode can be used as a counter electrode. The first electrode and the counter electrode can be partially submerged in the LiBF₄ solution. The first electrode and the counter electrode can be connected by a wire, which can also be connected to a voltage source. Using the voltage source, a positive voltage of about +1.0V can be applied between the first electrode and the counter electrode until the reaction ceases (e.g., the electric current between the first and second electrodes can be close to zero). Next, a negative voltage of about −1.0 V can be applied between the first electrode and the counter electrode until the reaction ceases (e.g., the electric current between the first and second electrodes can be close to zero). The cycle of applying a positive voltage of about +1.0 V and a negative voltage of about −1.0V can be repeated for three to ten times, or any number of repetitions therebetween. Nanoparticles of Ti and Al mixture can be produced. If the last delithiation process is skipped (i.e., the step of applying a negative voltage of about −1.0V), a mixture of Ti and AlLi can be produced.

### EXAMPLE 4

### Formation of a Microparticles of Tin

A solution of LiBF₄ salt at a concentration of 1.0 mol/L in diethylene glycol can be prepared in a chamber at a temperature of about 30° C. A 15 g sample of a semiconductor material that includes Sn can be placed into a porous, non-reactive, and electrically-conductive container (first container) to form a first electrode. A Li₄Ti₅O₁₂ electrode can be used as a counter electrode. The first electrode and the counter electrode can be partially submerged in the LiBF4 solution. The first electrode and the counter electrode can be connected by a wire, which can also be connected to a voltage source: Using the voltage source, a positive voltage of about +0.7V can be applied between the first electrode and the counter electrode until the reaction ceases (e.g., the electric current between the first and second electrodes can be close to zero). Next, a negative voltage of about −0.7 V can be applied between the first electrode and the counter electrode until the reaction ceases (e.g., the electric current between the first and second electrodes can be close to zero). The cycle of applying a positive voltage of about +0.7V and a negative voltage of about −0.7V can be repeated for three to ten times, or any number of repetitions therebetween. Microparticles of above about 95% pure Sn can be recovered.

In the present disclosure, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 substituents refers to groups having 1, 2, or 3 substituents. Similarly, a group having 1-5 substituents refers to groups having 1, 2, 3, 4, or 5 substituents, and so forth.

1. A method for forming particles, the method comprising:
connecting a starting material as a first electrode in a circuit comprising the first electrode and a counter electrode each of which is at least partially disposed in an electrolyte, wherein:
the electrolyte comprises metal counter ions;
the counter electrode comprises a source of the metal counter ions; and
the starting material comprises at least one electrochemically reactive material which is electrochemically reactive to the metal counter ions;
applying a first voltage at a first magnitude, the first voltage applied between the first electrode and the counter electrode to ionize the source of metal counter ions to yield the metal counter ions, wherein the first magnitude of the first voltage causes at least some of the metal counter ions to selectively react with the at least one-electrochemically reactive material in the first electrode to form a metal-electrochemically reactive material compound;
applying a second voltage of opposite polarity to the first voltage to ionize the metal counter ions from the metal-electrochemically reactive material compound to recharge the counter electrode, thereby producing and releasing particles of the electrochemically reactive material; and
collecting the released particles.

2. The method of claim 1, wherein the starting material is selected from substantially pure material or waste material.

3-6. (canceled)

7. The method of claim 1, wherein the at least one electrochemically reactive material is reactive with Li, Na, K, Mg, salts, and ions thereof.

8. The method of claim 1, wherein the at least one electrochemically reactive material is selectively reactive with the metal counter ion at a voltage from 0.01 V-20V.

9. The method of claim 1, wherein the at least one electrochemically reactive material is selected from Si, Ga, Ge, Pt, Ag, Au, In, Sn, Al, Zn, Sb, Cd, As, Pb, Mg and combinations thereof.

10. The method of claim 1, wherein the metal counter ion is selected from K⁺, Li⁺, Na⁺, and Mg²⁺.

11. The method of claim 1, wherein the metal counter ion is Li⁺.

12-13. (canceled)

14. The method of claim 1, wherein the metal counter ion is Li⁺ and the source of the counter ions is Li metal, Li metal, LiFePO₄, LiCoO₂, Li₄Ti₅O₁₂, LiMn₂O₄, Li—Al, Li—Sb, Li—Sn, or combinations thereof.

15. The method of claim 1, wherein the electrolyte is non-aqueous.

16. The method of claim 15, wherein the electrolyte comprises a combination of an organic solvent and a salt of the metal counter ion.

17-19. (canceled)

20. The method of claim 16, wherein the organic solvent is selected from propylene carbonate, ethylene carbonate, ethyl carbonate (EC), diethyl carbonate (DEC), dimethyl carbonate, 1,2-dimethoxyethane, diethylene glycol dimethyl ether, diethylene glycol diethyl ether, diethylene glycol dibutyl ether, dipropylene glycol dimethyl ether, diethoxyethane, BEE-1-tert-butoxy-2-ethoxyethane and mixtures thereof.

21. The method of claim 1, further comprising cycling between applying the first voltage and applying the second voltage until the electrochemically-active material forms grains or particles of a desired size.

22. The method of claim 1, further comprising applying the first voltage to selectively react the counter ions with a selected electrochemically reactive material.

23. The method of claim 21, wherein the first magnitude is correlated to a reaction voltage of the first electrochemically reactive material.

24. The method of claim 22, further comprising applying the first voltage at a second magnitude to selectively recover a second electrochemically-active material, the second magnitude correlated to a reaction voltage of the second electrochemically reactive material.

25. The method of claim 22, wherein the second magnitude is greater than the first magnitude.

26. The method of claim 1, wherein the metal-electrochemically reactive material compound increases at least about 20% in volume compared to a compound of the starting material that comprises the electrochemically reactive material.

27. The method of claim 21, wherein the cycling comprises a formation and a disassociation of the metal-electrochemically reactive material compound, the cycling generating internal stresses that result in a pulverization of the electrochemically reactive material.

28. The method of claim 1, further comprising separating particles of the at least one electrochemically reactive material from any unreacted material.

29. The method of claim 1, further comprising forming an alloy comprising the particles of the at least one electrochemically reactive material and at least a portion of the starting material.

30. The method of claim 28, wherein the particles of the electrochemically reactive material comprise particles of the metal-electrochemically reactive material compound

31. The method of claim 1, wherein the particles or fine grains are formed in a surface layer of a bulk material.

32. A method for forming nanoparticles, the method comprising:
connecting a starting material as a first electrode in a circuit comprising the first electrode and a counter electrode each of which is at least partially disposed in an electrolyte, wherein:
the electrolyte comprises lithium counter ions (Li⁺);
the counter electrode comprises a lithium metal or a lithium salt as a source of the lithium counter ions (Li⁺);
the starting material comprises M, wherein M is at least one electrochemically reactive material selected from Si, Ga, Ge, Pt, Ag, Au, In, Sn, Al, Zn, Sb, Cd, As, Pb, Mg and combinations thereof;
applying a first voltage of at a first magnitude of about 0.01V-20V, between the first electrode and the counter electrode, to ionize the source of lithium counter ions to yield the lithium counter ions, wherein at least some of the lithium counter ions selectively react with the at least one electrochemically reactive material in the first electrode to form a LiₓM_{y} compound;
wherein LiₓM_{y} represents a compound exhibiting at least about a 20% change in unit volume compared to a compound of the starting material that comprises the electrochemically reactive material; and applying a second voltage of opposite polarity to the first voltage to ionize the Li counter ion from the LiₓM_{y} compound, thereby producing substantially purified and pulverized particles of M.

33. The method of claim 32, wherein M comprises Si and the particles comprise nanoparticles.

34. (canceled)

35. The method of claim 32, wherein the first voltage is about 0.01V-0.5V.

36. (canceled)

37. An apparatus for generating nanoparticles, the apparatus comprising:
an electrical circuit comprising:
a first electrode comprising a porous, non-reactive container for housing at least one electrochemically reactive material which is electrically coupled as at least a portion of the first electrode, wherein the porous, non-reactive container is provided with a plurality of apertures to allow pulverized particles to pass therethrough for collection;
a second container, open at one side, to allow the pulverized particles to collect therein;
a counter electrode comprising a source of metal counter ions; and
an electrolyte comprising the metal counter ions;
wherein the first electrode and the counter electrode are electrically coupled to one another for applying a voltage therebetween and each of the first electrode and the counter electrode are at least partially disposed within the electrolyte.

38-39. (canceled)
